(19) United States
(12) Patent Application Publication
(10) Pub. No.: US 2017/0042642 A1
(43) Pub. Date: Feb. 16, 2017

(54) SELF-LIGATING BRACKET WITH FITTING SYSTEM FOR FLEXIBLE, PASSIVE AND INTERACTIVE CLIP

(71) Applicant: Alexandre GALLO LOPES, Ribeirão Preto (BR)

(72) Inventor: Alexandre GALLO LOPES, Ribeirão Preto (BR)

(21) Appl. No.: 15/118,051

(22) PCT Filed: Feb. 9, 2015
(86) PCT No.: PCT/IB2015/050958

§ 371 Date: Oct. 28, 2016

(30) Foreign Application Priority Data
Feb. 10, 2014 (BR) BR1020140030751

(51) Int. Cl. A61C 7/30

(52) U.S. Cl. CPC A61C 7/30

(57) ABSTRACT

A self-ligating bracket with a fitting system for a flexible, passive and interactive clip consists of a bracket (1) with structural elements represented by an elongate protrusion (2) and a coupling channel (3) for the flexible clip (4) with free ends (5) in the body (6) of the receiving piece, or in a second version of the bracket (7), with a pointed protrusion (8) and coupling channel (3) delimited by lower ties (9), the bevels (10) of which allow the middle section of the flexible clip (4) to be deflected (11), so as to confront the free, juxtaposed ends (5), which are retained under the upper ties (12).

The present application for an invention relates to a novel “SELF-LIGATING BRACKET WITH FITTING SYSTEM FOR FLEXIBLE, PASSIVE AND INTERACTIVE CLIP”, in particular to a bracket which is provided with a system for fitting a flexible clip with open, overstepped free ends, in an area delimited between a protrusion and the base, or between a protrusion and the lower part of the lower fastening fins, thus permitting insertion, coupling, retention and interaction with the arch, and interchangeability in accordance with the stage of treatment, therefore making it possible to vary the resistance to slippage.

The invention in question is applied to the field of odontology, but specifically to the orthodontics specialty which aims to correct mandibular discrepancies and incorrect positioning of teeth, whether on their vestibular or lingual faces.

The brackets are secured on the surface of the teeth by means of techniques which are widely known and of proven efficiency, such as direct gluing with dental resin on the vestibular and lingual surfaces, and are used as a support for the elements or accessories such as resilient, spring and elastic arches which, once they are activated, store energy for transmission of forces to the brackets, which move the teeth in the direction of their correct positioning.

The brackets must provide attachment or gripping of the orthodontic arch inside its channel, in a manner which is secure and foreseeable when being handled by a professional. The lack of standardization in putting into place ligatures which are made of annealed stainless steel wire provides a heterogeneous interface without interactivity, which can vary from one professional to another.

Thus, the self-ligating brackets provide ease of putting into place and removing the orthodontic arches, and also eliminate the repetitive movements of this task compared with the conventional methods for putting metal or elastomer ligatures into place, consequently reducing the incidence of repetitive strain injury amongst the professionals.

The mechanical advantages of the self-ligating brackets include the use of lower force modules, as a result of the elimination of most of the friction caused by the elastomer and metal ligatures.

The facilitated clinical management is beneficial for the professional in terms both of handling and saving of time.

For the patient, the risk of iatrogenia caused by the movement of the teeth using high levels of force is minimized by the application of less intense force modules within the passive or active interface of the self-ligating bracket.

There is also a significant reduction in the number of consultations in order to carry out the treatment, to the benefit of the patient and the professional.

The phases of orthodontic treatment require different forces in the clip/arch interface. In the initial phase, it is important to obtain a passive interface in which pressure of the clip on the arch does not occur. In addition, in the intermediate and final phases, the requirements for force/interactivity between the arch and the clip must be altered by means of mechanics with generation of torque with greater friction, in order to consolidate the positioning of the teeth or impart the inclinations and angles which are inherent in the prescriptions of the brackets.

For teeth which need to be moved, use is made of clips which produce passive interfaces, or interactive clips in order to consolidate/anchor the position of the teeth or groups of teeth for movement of other segments of dental arch.

In this context, at each stage of the treatment, the professional must select the tooth or groups of teeth for which the resistance to slipping in the interface needs to be varied, by changing the flexible clip to the one which is most suitable for that phase, so as to facilitate the clinical handling.

The prior art incorporates some patent documents which relate to brackets with clips with variable resistance, such as document US 4260375 which concerns a bracket with a clip with a spring effect consisting of two sections, the first being formed by two elongate elements which are designed to re-cover the groove in the bracket, whilst the second section opposes the first, entering the body of the bracket in question.

The clip concerned has a system for fitting in the bracket according to a horizontal orientation, which makes it more difficult for the professional to handle. Furthermore, since the free ends are not juxtaposed, any excessive deflection of the arch can assist the disengagement of the clip.

Aware of the prior art and its gaps and limitations, after carrying out studies and research, the inventor, which is a body familiar with the subject concerned, has created the “SELF-LIGATING BRACKET WITH FITTING SYSTEM FOR FLEXIBLE, PASSIVE AND INTERACTIVE CLIP” in question, which has structural elements in the base of the bracket, or, in another version, between the base and the lower fastening fins, which permit the insertion, coupling and retention of a clip by means of the deflection of its median section, thus making possible tilting movements in order to open and expose the groove in the bracket which receives the orthodontic arch kept securely in position, thus constituting the groove/orthodontic arch interface for interaction and transmission of forces for dental movement. When the free ends of the are clip opened or are displaced on the three planes in space, they absorb the excess energy and intervene in the resistance to slipping, as well as in transmission of the forces derived from the deflection of the orthodontic arch, thus creating a type of interaction with the arch.

In the “SELF-LIGATING BRACKET WITH FITTING SYSTEM FOR FLEXIBLE, PASSIVE AND INTERACTIVE CLIP”, in a first version the structural elements for retention and fitting of the clip are located in the body of the bracket/in the upper face of the gluing base, or, in a second version, they are located below the fastening fins. The structural elements for retention and fitting are constructed in the region of greatest mechanical resistance of the bracket, in order to withstand the force and tension demands generated in the chewing process.

In the “SELF-LIGATING BRACKET WITH FITTING SYSTEM FOR FLEXIBLE, PASSIVE AND INTERACTIVE CLIP”, the positioning of the structural elements and of the clip provides an opening which permits easy access for brushing and hygiene, therefore preventing the accumulation of food particles and bacterial plaque which lead to the formation of calculus and tartar, which could cause inflammation of the gums, to the detriment of the satisfactory progress of the orthodontic treatment.

In the “SELF-LIGATING BRACKET WITH FITTING SYSTEM FOR FLEXIBLE, PASSIVE AND INTERACTIVE CLIP”, the reduction of friction promotes the transmission of forces more gently, and in a manner which is biocompatible with the system for care of the teeth.

In the “SELF-LIGATING BRACKET WITH FITTING SYSTEM FOR FLEXIBLE, PASSIVE AND INTERACTIVE CLIP”, in the stages of the treatment which require torque with greater friction, the clip can be replaced individually or in a set of brackets, thus permitting the change of friction load in the groove/orthodontic arch interface according to use of a clip with a different geometric configuration, combined with materials with different thicknesses, geometries and states of hardness.

In the “SELF-LIGATING BRACKET WITH FITTING SYSTEM FOR FLEXIBLE, PASSIVE AND INTERACTIVE CLIP”, the clip can be produced using an immense range of materials and production processes, since its geometric configuration and design are not factors which impede this. Metals which are resilient and/or can be hardened, such as stainless steel, chromium-cobalt and titanium/molybdenum and their alloys, or materials with form memory, such as titanium and its alloys, nitinol and its alloys, CuNiTi and its alloys, compounds, plastics, hybrid resins with inorganic fillers, nano-materials or hybrid resin with fibers for structural reinforcement can be used. The processes for production of the clip include: stamping, forming, photo-etching, injected metal and subsequent sintering, micro-fusion and injection of plastics, compounds and hybrid resins.

The “SELF-LIGATING BRACKET WITH FITTING SYSTEM FOR FLEXIBLE, PASSIVE AND INTERACTIVE CLIP” preferably has a low-profile body provided with a groove for insertion of the arch located centrally, and can have single or double fastening fins, i.e. one upper and the other one lower. The base for gluing the bracket to the tooth can form part of the body or be incorporated with it by means of welding, in an operation carried out during the production process.

The invention will be described hereinafter with reference to the appended drawings, which represent the following in an illustrative and non-limiting manner:

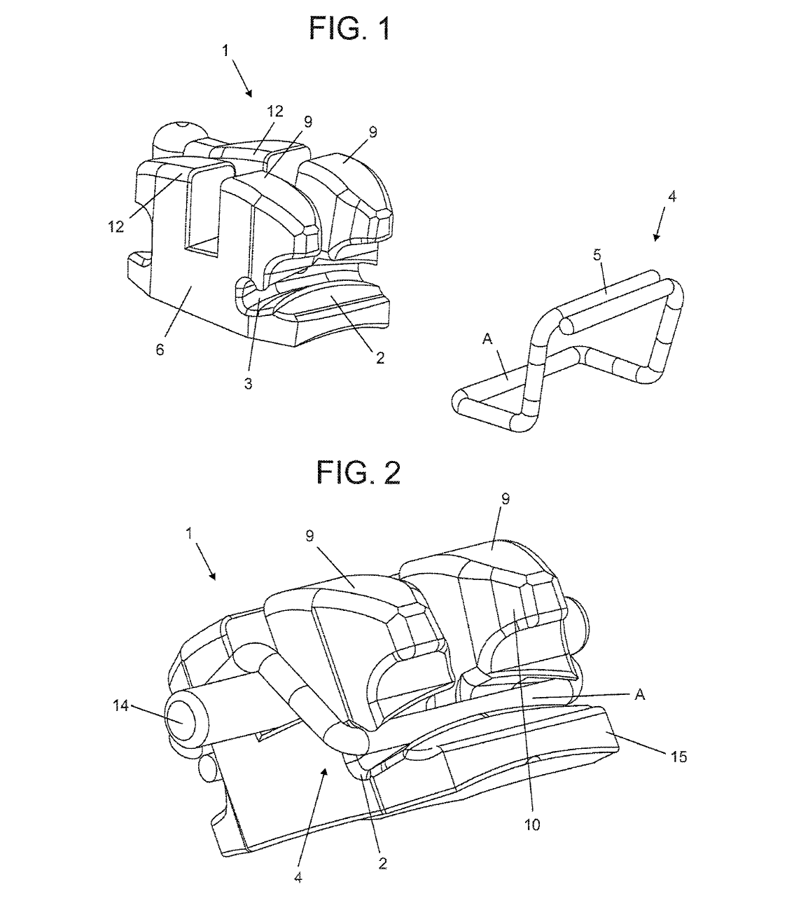

FIG. 1 is an exploded view in perspective of the self-ligating bracket with fitting system for flexible, passive and interactive clip;

FIG. 2 is a view in perspective of the self-ligating bracket with fitting system for flexible, passive and interactive clip, with the arch enclosed;

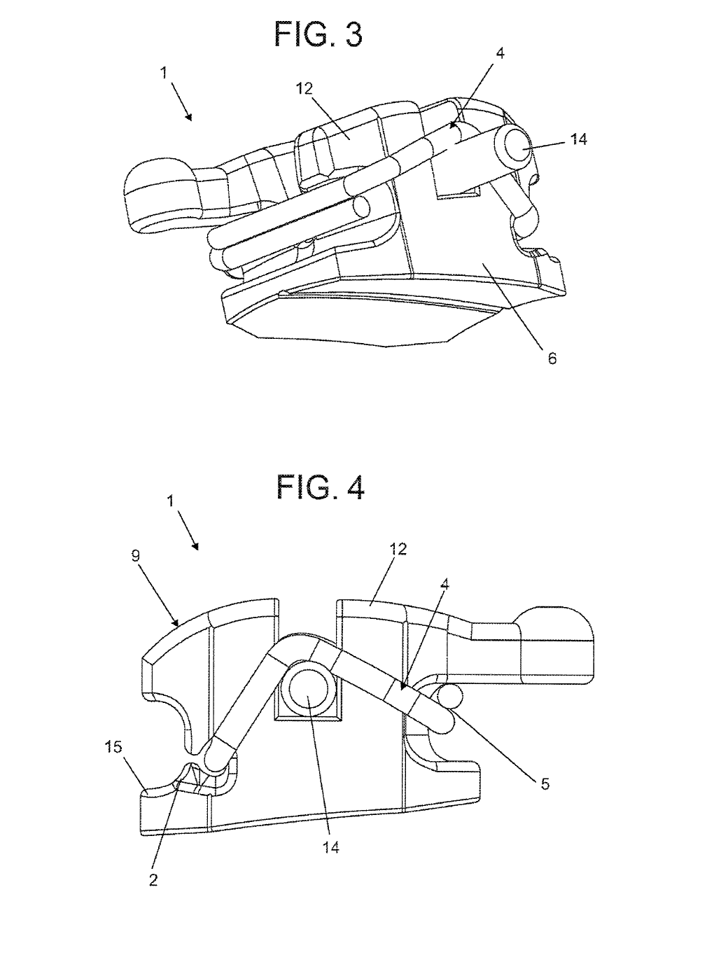

FIG. 3 is a inverted view in perspective of the self-ligating bracket with fitting system for flexible, passive and interactive clip, with the arch enclosed;

FIG. 4 is a lateral view of the self-ligating bracket with fitting system for flexible, passive and interactive clip, with the arch enclosed;

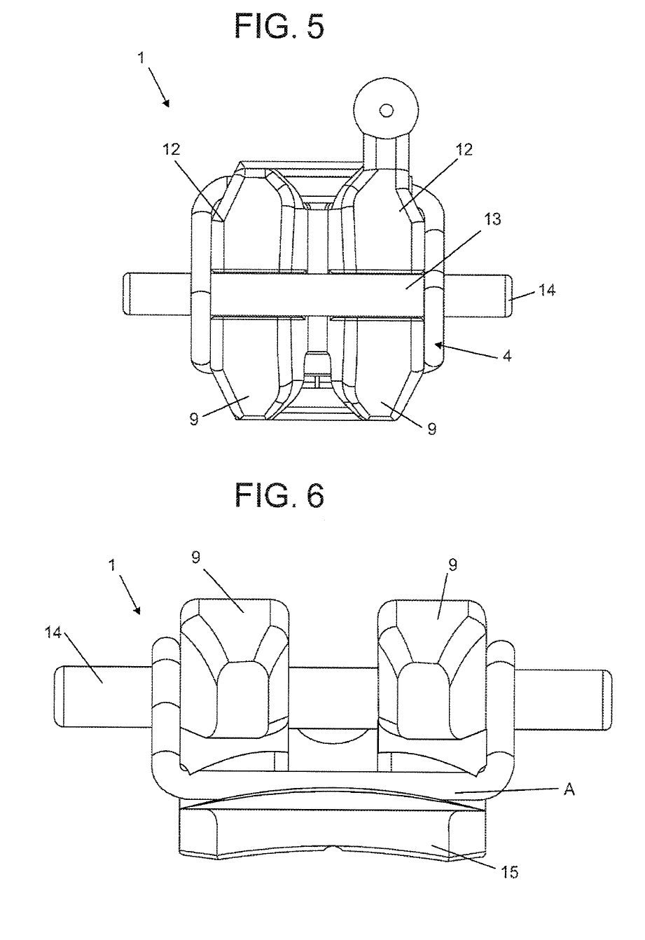

FIG. 5 is a front view of the self-ligating bracket with fitting system for flexible, passive and interactive clip, with the arch enclosed;

FIG. 6 is a view from below of the self-ligating bracket with fitting system for flexible, passive and interactive clip, with the arch enclosed, and detail of deflection of the clip;

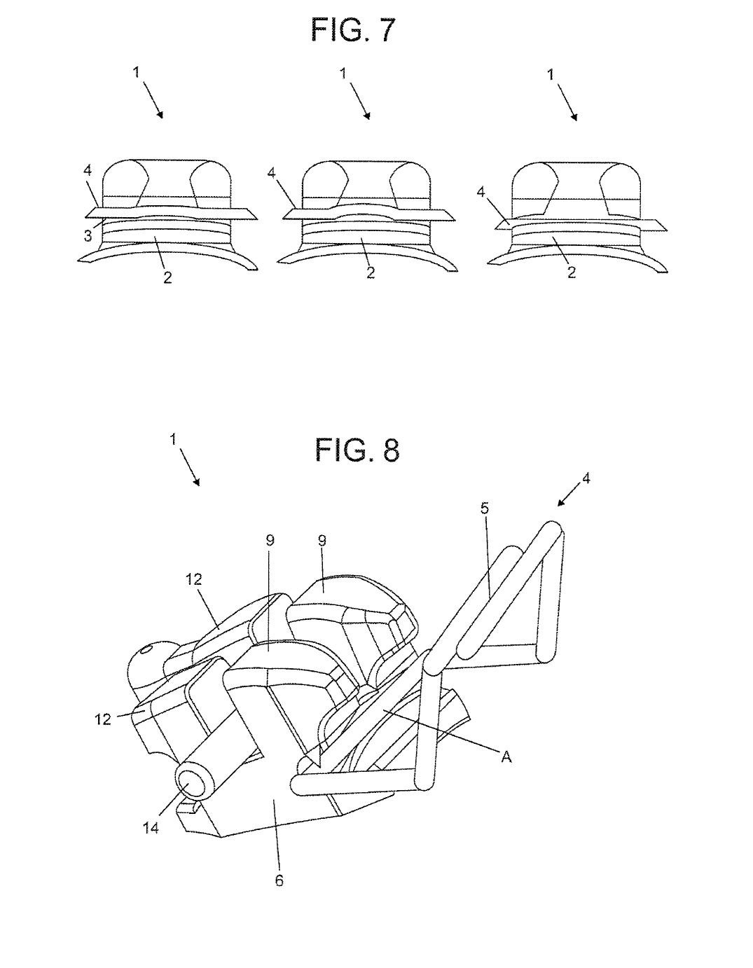

FIG. 7 is a schematic view of the self-ligating bracket with fitting system for flexible, passive and interactive clip, showing the sequence of insertion and retention of the arch;

FIG. 8 is a view in perspective of the self-ligating bracket with fitting system for flexible, passive and interactive clip, showing the clip open;

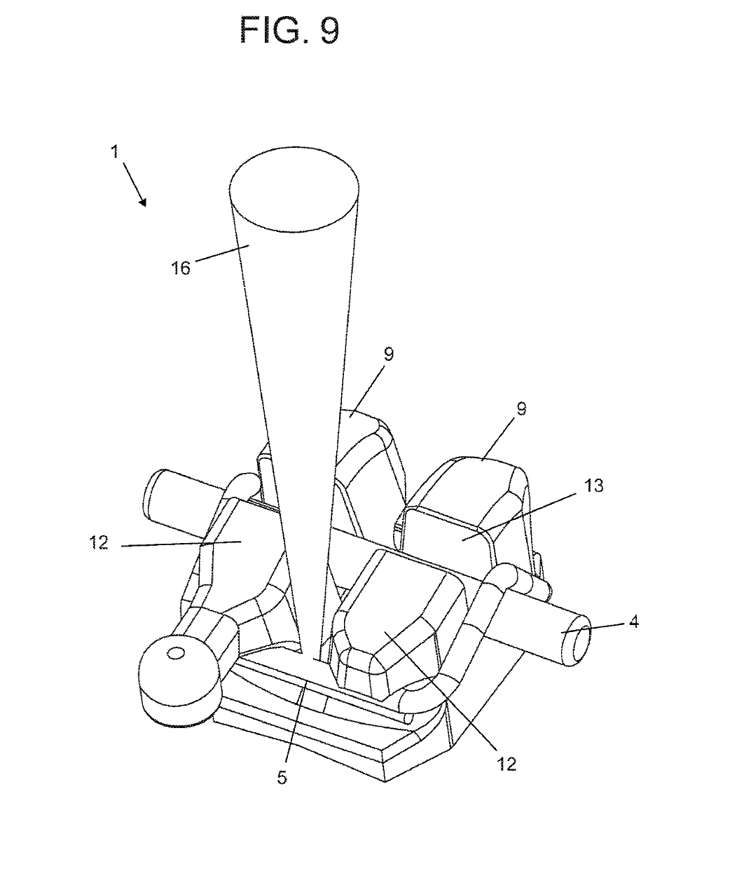

FIG. 9 is a view in perspective of the self-ligating bracket with fitting system for flexible, passive and interactive clip, showing removal of the clip;

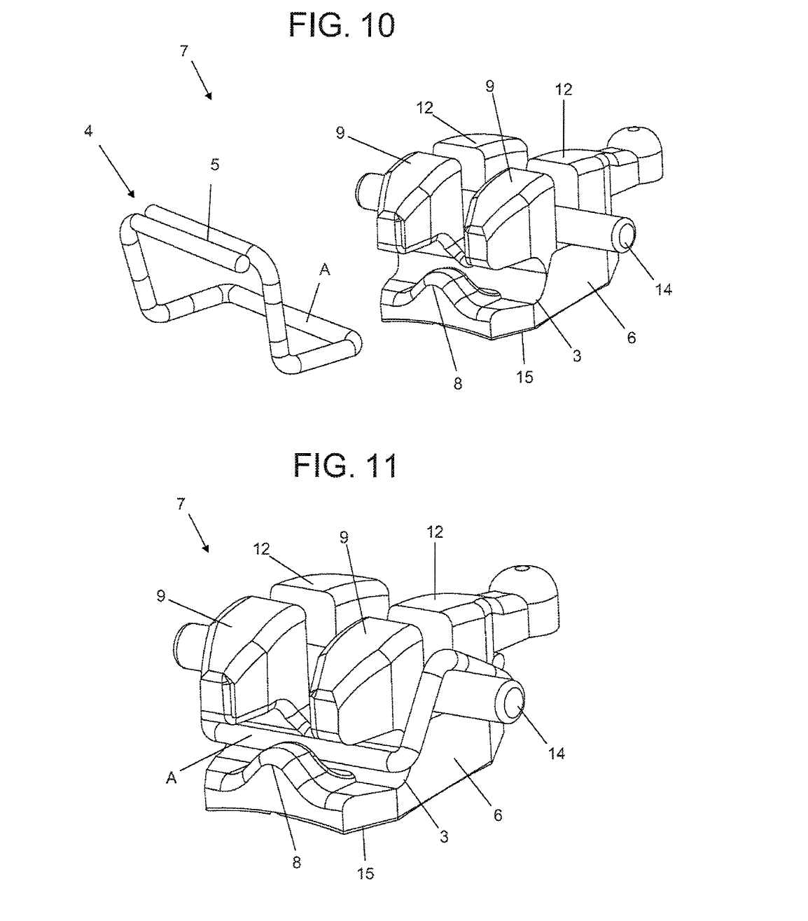

FIG. 10 is an exploded view in perspective of the self-ligating bracket with fitting system for flexible, passive and interactive clip in a structural variant;

FIG. 11 is a view in perspective of the self-ligating bracket with fitting system for flexible, passive and interactive clip in a structural variant, with the arch enclosed;

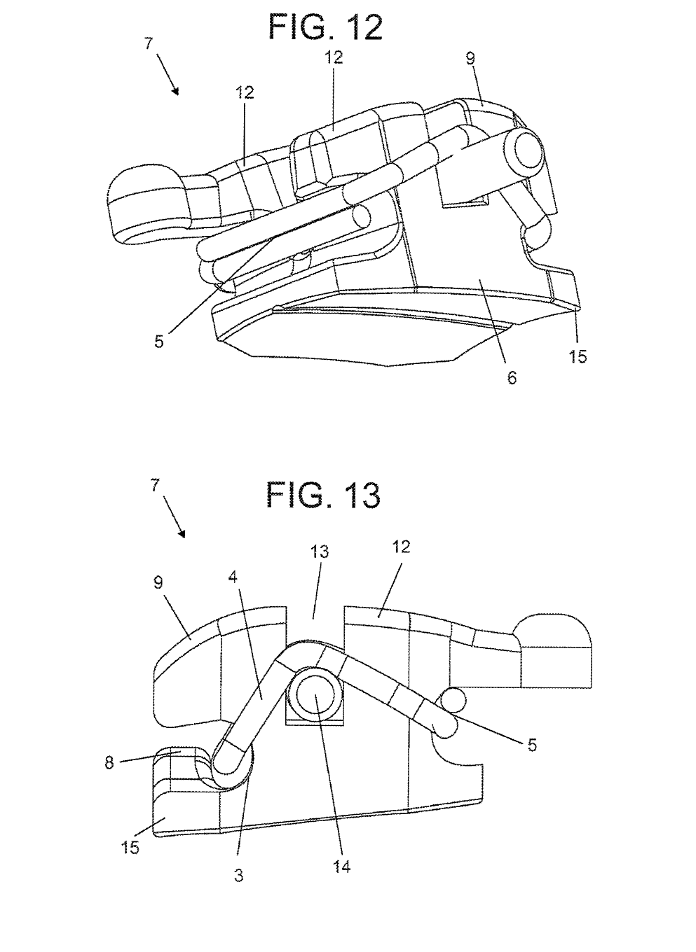

FIG. 12 is a inverted view in perspective of the self-ligating bracket with fitting system for flexible, passive and interactive clip in a structural variant, with the arch enclosed;

FIG. 13 is a lateral view of the self-ligating bracket with fitting system for flexible, passive and interactive clip in a structural variant, with the arch enclosed;

FIG. 14 is a front view of the self-ligating bracket with fitting system for flexible, passive and interactive clip in a structural variant, with the arch enclosed;

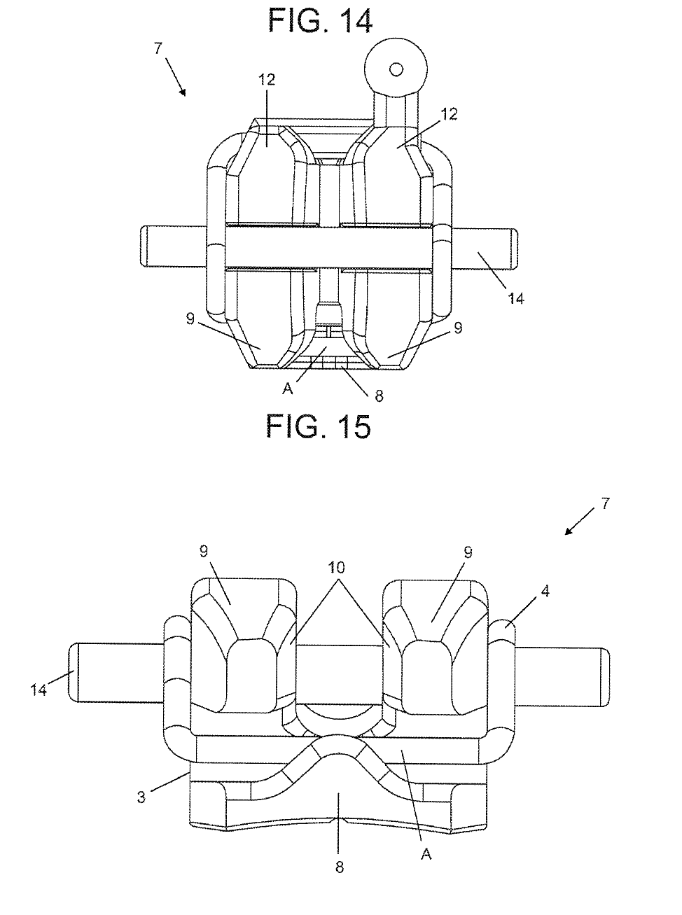

FIG. 15 is a view from below of the self-ligating bracket with fitting system for flexible, passive and interactive clip in a structural variant, with the arch enclosed, and detail of deflection of the clip;

FIG. 16 is a schematic view of the self-ligating bracket with fitting system for flexible, passive and interactive clip in a structural variant, showing the sequence of insertion and retention of the arch;

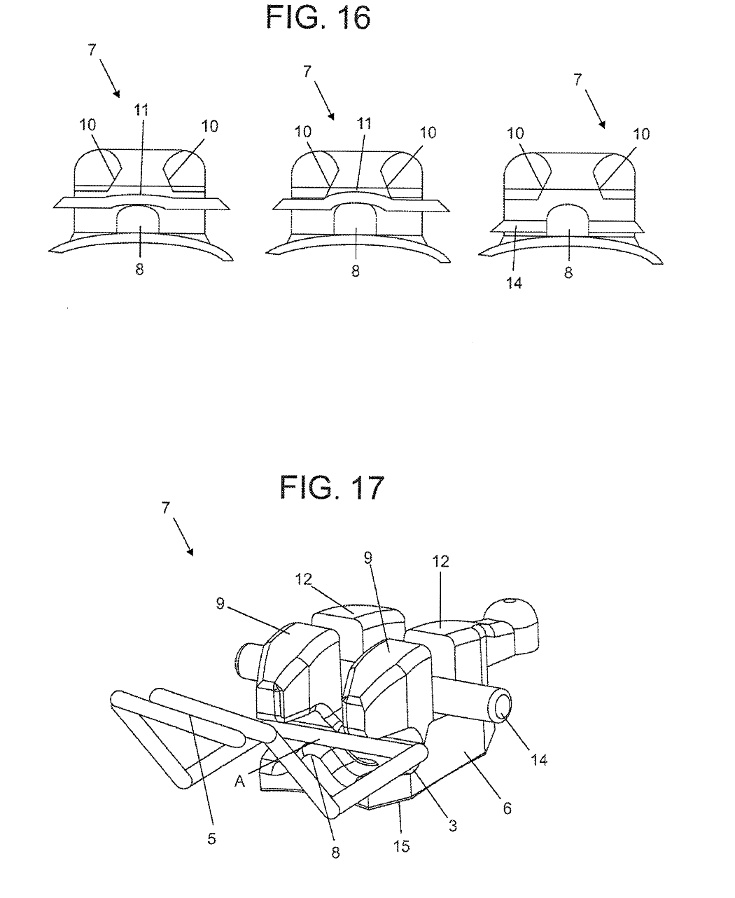

FIG. 17 is a view in perspective of the self-ligating bracket with fitting system for flexible, passive and interactive clip in a structural variant, showing the clip open;

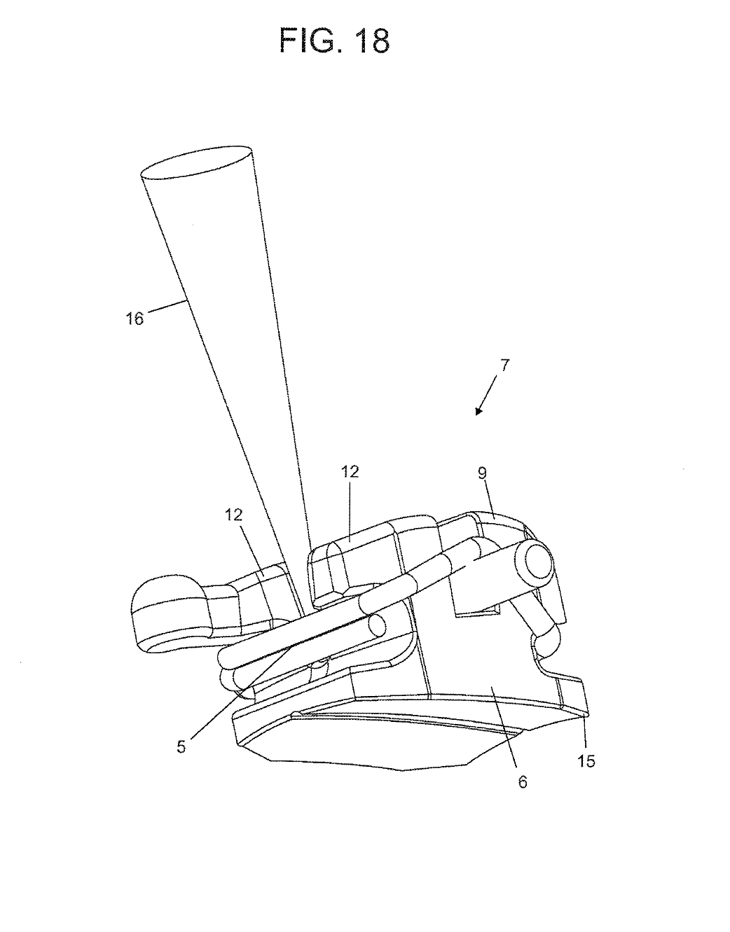

FIG. 18 is a view in perspective of the self-ligating bracket with fitting system for flexible, passive and interactive clip in a structural variant, showing removal of the clip.

The “SELF-LIGATING BRACKET WITH FITTING SYSTEM FOR FLEXIBLE, PASSIVE AND INTERACTIVE CLIP” which is the subject of this application for a patent of invention consists of a bracket 1 with structural elements represented by an elongate protrusion 2 and groove 3 for coupling of the flexible clip 4 with free ends 5 exclusively in the body 6 of the receiving piece, or in a second version of the bracket 7 with a pointed protrusion 8 and coupling groove 3 delimited by the lower fastening fins 9, the bevels 10 of which permit the deflection 11 of the median section A of the flexible clip 4, so as to oppose the free juxtaposed ends 5 which are retained under the upper fastening fins 12.

More particularly, the invention presents two versions of brackets 1 and 7 with structural elements which permit the insertion, tangential tilting, retention and easy interchangeability of the flexible clip 4 with free ends 5 by means of the deflection 11 of its median section A, in the first version of the bracket 1, with the structural elements exclusively in its body 6, over an elongate protrusion 2 and into a coupling groove 3, and in the second version of the bracket 7 over a pointed protrusion 8 and into a coupling groove 3 delimited by the lower fastening fins 9, in this case with functional appeal, since its bevels 10 provide space for the deflection 11 of the median section A of the flexible clip 4. Thus, the flexible clip 4 tilts, outlining an arch along the outer face of the bracket 1 and 7, from an open position, exposing the insertion groove 13, to a closed position when it encloses the orthodontic arch 14, and the free ends 5 are placed below the upper fastening fins 12. Thus, the median section A of the flexible clip 4 turns in the interior of the insertion groove 13 around its own axis, which has outlining in the form of a half-round bar or therefore a “C” in the medio-distal longitudinal direction and parallel to the coupling groove 3, with the outlining delimited by the upper and rear walls of the body of the bracket, and by the outer face 15 of the gluing base. The protrusion 2 and 8 is an integral part of the body of the bracket, and more specifically of the outer face 15 of the gluing base, which does not remain in contact with the vestibular or lingual outer face of the tooth, thus forming a fourth wall which is slightly spaced from the coupling groove of the flexible clip 4. According to FIGS. 6 and 7, in the first version of the bracket 1 the flexible clip 4 has its free ends 5 positioned below the upper fastening fins 12, and is placed in the coupling groove 3 by the vertical deflection of its median section A, thus necessitating transposition via the protrusion 2, the elongate outline of which does not propitiate mechanical interference with the lower fastening fins 9. According to FIGS. 15 and 16, in the second version of the bracket 7, the flexible clip 4 is placed in the coupling groove 3 by the vertical deflection of its median section A, thus necessitating transposition via the protrusion 2, the pointed outline of which would interfere with the lower fastening fins 9 if the space derived from the bevels 10 did not exist. With these structural elements, the flexible clip 4 tilts without the risk of being uncoupled from the coupling groove 3, and it fulfils perfectly its function of taking the orthodontic arch 14, and also interacting with it, thus affecting directly the resistance to slipping. As well as preventing disengagement from the bracket 1 and 7, the juxtaposed free ends 5 of the flexible clip 4 also make possible the constitution of passive and/or interactive interfaces, thus complying with the needs of the treatment stage/forces required for dental movement, which are dependent on the geometry, gauge, material and heat treatment of the wire with which it is made. A structural variant of the flexible clip 4 has the free ends 5 sheathed with a tube which makes this section rigid or semi-rigid, thus limiting the range of action of the part. As illustrated in FIGS. 9 and 18, in order to open the flexible clip 4, the tip of a tool 16 is inserted between the lower fastening fins and on the free ends 5, separating them so that the part can tilt along the perimeter of the bracket, from the closed position to the open position, or vice versa.

1. A bracket and fitting system characterized in that it has structural elements exclusively in the body of the bracket or incorporating the lower fastening fins in the bracket, which permit the insertion, tilting, coupling, retention and easy interchangeability of a flexible clip with ends which are free and juxtaposed by the vertical deflection of its median section (A).

2. The bracket and fitting system as claimed in claim 1, characterized in that, in the bracket, the structural elements consist of an elongate protrusion and coupling groove of the flexible clip.

3. The bracket and fitting system as claimed in claim 1, characterized in that, in the bracket, the structural elements consist of a pointed protrusion, and a coupling groove which is delimited by the lower fastening fins.

4. The bracket and fitting system as claimed in claim 1, characterized in that the lower fastening fins have functional appeal.

5. The bracket and fitting system as claimed in claim 1, characterized in that the bevels provide space for the vertical deflection of the median section (A) of the flexible clip.

6. The bracket and fitting system as claimed in claim 1, characterized in that the juxtaposed free ends of the flexible clip prevent its disengagement from the bracket, and permit the constitution of passive and/or interactive interfaces.

7. The bracket and fitting system as claimed in claim 6, characterized in that the juxtaposed free ends have their free ends sheathed by a tube.

8. The bracket and fitting system as claimed in claim 1, characterized in that, by means of the geometry, gauge, material and heat treatment of the wire with which the flexible clip is made, it is possible to constitute the various interfaces.
